(19) United States
(12) Patent Application Publication
(10) Pub. No.: US 2018/0195488 A1
(43) Pub. Date: Jul. 12, 2018

(54) RUNNER OF A PELTON TURBINE

(71) Applicant: VOITH PATENT GMBH, HEIDENHEIM (DE)

(72) Inventors: MARTIN ROHRER, ST. VEIT/GOELSEN (AT); THOMAS SCHUBERT, LEHENROTTE (AT)

(21) Appl. No.: 15/742,596

(22) PCT Filed: May 25, 2016
(86) PCT No.: PCT/EP2016/061746

§ 371 Date: Jan. 8, 2018

(30) Foreign Application Priority Data
Jul. 7, 2015 (DE) 102015212624.2

(51) Int. Cl. F03B 1/02

(52) U.S. Cl. CPC F03B 1/02; F05B 2230/60; F05B 2230/232

(57) ABSTRACT

A runner for a Pelton turbine has a multiplicity of buckets which are arranged on a disk-shaped wheel and which each have a bucket root directly adjoining the wheel and a bucket body. The disk-shaped wheel, with the bucket roots, is formed in one piece from a forged material. Separately produced bucket bodies, formed of three separate parts per bucket, are connected by welding to the respectively associated bucket root. A first part encompasses the entire part of the bucket body that extends radially beyond the bucket root, and two other parts, axially adjacent to the bucket root, encompass the rest of the bucket body.

The present invention relates to a runner of a Pelton turbine with a multiplicity of buckets which are arranged on a disk-like wheel.

On account of the high demands on the material quality with regard to strength and service life, it would be desirable to produce runners for a Pelton turbine in one piece from a large forged disk by milling from the whole piece. Particularly in the case of runners with large diameters this method is not economical, however, since the production of a forged blank in the required size is very costly.

Known from the prior art (see for example EP 0 882 888 A1) are runners for a Pelton turbine which solve this problem by only the wheel hub with the bucket roots being produced from a forged blank, and by the bucket bodies being connected in one piece (see EP 0 882 888 A1, FIG. 5) or in a plurality of pieces (see EP 0 882 888 A1, FIG. 3) to the bucket roots, for example by welding. As a result, the required size of the forged blank is appreciably reduced.

The inventors have set about the task of further improving the runner known from the prior art with regard to the production costs. The inventors have recognized that on the one hand the length of the required weld seam and on the other hand the size of the parts which are to be welded on constitute cost drivers for the production. In practice, specifically the welded on bucket parts are also produced from forged material, and for these it is also more cost-effective if the respective blanks can be selected as small as possible.

The solution according to the invention is explained below with reference to figures. In detail, in the drawing below:

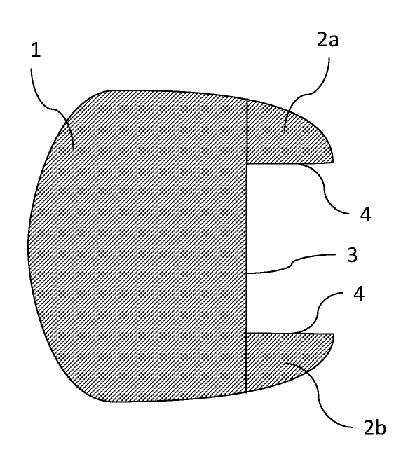

FIG. 1 shows an arrangement according to the invention of the bucket parts which are to be welded on.

Shown in FIG. 1, for the arrangement according to the invention, are the bucket parts which are welded onto an associated bucket root in each case. In this case, a bucket part which adjoins the bucket root in the radial direction with regard to the runner axis is designated 1. An edge 3, which constitutes the boundary of the bucket roots in the radial direction, constructionally defines the bucket part 1.

Furthermore, bucket parts which adjoin the bucket root in the axial direction are designated 2a and 2b. The bucket root terminates in the axial direction at the edges which are designated 4. For each bucket, 3 bucket parts are therefore welded onto the respective bucket root. In this case, weld seams are required along the edges 3 and 4. The weld seam also connects the bucket parts 2a and 2b to the bucket part 1 along the edge 3. The bucket part 1 therefore comprises the entire part of the bucket body which extends in the radial direction beyond the limit of the bucket roots, and the bucket parts 2 adjoin the bucket root in the axial direction in each case and comprise the remaining part of the bucket body.

The advantages of the arrangement according to the invention can be best explained in comparison to FIG. 5 from EP 0 882 888 A1. From FIG. 5 it is evident that the bucket part which is to be welded on consists of the whole bucket in one part without the bucket root. Weld seams extend along the edges 12 and 13. In the arrangement according to the invention according to FIG. 1, the size of the required forged blanks for the bucket parts which are to be welded on is appreciably smaller since the maximum size corresponds only to the size of the bucket part 1. This reduction is gained at the cost of a slightly longer weld seam (the connection between the bucket parts 1 and 2 along the edge 3). This elongation, however, is of much less consequence with regard to cost so that the arrangement according to the invention according to FIG. 1 is more cost-effective to produce than the arrangement according to FIG. 5 from EP 0 882 888 A1.

The runner according the invention can be produced in a particularly cost-effective manner by welding by means of a narrow-gap method.

1-2. (canceled)

3. A runner of a Pelton turbine, comprising:
a disk-shaped wheel;
a multiplicity of buckets supported on said disk-shaped wheel, each of said buckets having a bucket root directly adjoining said wheel, and a bucket body;
said disk-shaped wheel together with said bucket roots being formed in one piece from a forged material;
said bucket body of each of said multiplicity of buckets having three separate parts welded to a respectively associated said bucket root, a first part of said three separate parts forming an entire part of said bucket body that extends in a radial direction across said bucket root, and two further parts of said three separate parts axially adjoining said bucket root and forming a remainder of said bucket body.

4. The runner according to claim 3, wherein said three separate parts of said bucket are welded onto the respective said bucket root by a narrow-gap welding process.
